(19) United States
(12) Patent Application Publication
(10) Pub. No.: US 2008/0201454 A1
(43) Pub. Date: Aug. 21, 2008

(54) Multi-Level Thin-Clients Management System and Method

(75) Inventor: Aviv Soffer, Ein Ayala (IL)

Correspondence Address: WOLF, BLOCK, SHORR AND SOLIS-COHEN LLP, 250 PARK AVENUE, 10TH FLOOR, NEW YORK, NY, 10177, US

(73) Assignee: CHIPPC ISRAEL LTD., Tirat Hacarmel (IL)

(21) Appl. No.: 11/916,724

(22) PCT Filed: Jun. 6, 2006
(86) PCT No.: PCT/IL2006/000655

§ 371 Date: Dec. 6, 2007

Related U.S. Application Data
(60) Provisional application No. 60/688,241, filed on Jun. 6, 2005.

(51) Int. Cl. G06F 15/177

(52) U.S. Cl. 709/220

(57) ABSTRACT

A system and method for managing connections between a proxy server and a distination server are provided. The multi-level thin-clients management system (TCMS) comprises a representation of the managed organization structure, per-level configurable management parameters and administrative permissions, management console adapted to enable user interaction for administrative purposes, database containing management parameters, Front End Servers adapted to foreward client management information to the TCMS and apply management rules, control functions on clients, and managed device having management agent adapted to communicate and to enable management by the TCMS.

### FIELD OF THE INVENTION

The present invention relates in general to management software and, in particular, to a system and a method for efficiently managing thin-client infrastructure including users, servers, devices and databases in a distributed computing environment.

### BACKGROUND OF THE INVENTION

Thin Client Management System, or simply “TCMS,” is playing an increasingly important role in network corporate management as thin clients becoming more popular. The present invention provides a TCMS that enables organizations to deploy and maintain large number of thin-clients in a structured and efficient manner through the use of similar tools available today for fat-clients (PCs). TCMS of the present invention can integrate management parameters for the system administrators from various managed devices including thin-clients, PCs, servers and users.

FIGS. 1-5 review some system and methods used in the art.

### SUMMARY OF THE INVENTION

The present invention provides a system and method for managing connections between a proxy server and a destination server. Request, expected response, and connection attributes are used to determine the connection along which each
Standard MMC snap-in administration tool
Combines logical (Directory Service based) and physical (Network Topology) management models
Uses existing Directory Service Tree structure to perform management tasks.
Assign management policies to devices in any Directory level.
Scalable by adding TCMS Front End-Servers to the TCMS Farm as needed.
Fault tolerant through Redundancy & Load Balancing
Centralized remote deployment of software to devices
Centralized configuration, upgrade and troubleshooting of devices
Uses existing Directory Service permission delegation and inheritance model to assign management permissions.
Uses an Independent Management Protocol that has built-in support for: SSL Encryption, Compression, Port Number Control, Bandwidth Control and more.
Optimized for enterprise network-infrastructure by using TCMS Sites and Site servers for bandwidth optimization

According to an exemplary embodiment of the current invention, a Multi-level Thin-clients management system (TCMS) is provided having: Graphical/textual or symbolic representation of the managed organization structure; Per-level configurable management parameters; and Per-level configurable administrative permissions; Management console to enable user interaction for administrative purposes; Database containing management parameters, settings, policies, software components, logs and other needed data; Front End servers responsible for forwarding client management information to the TCMS and for applying management rules, control functions and optionally software deployment on the clients; and Managed device having management agent adapted to communicate and to enable management and software deployment by said TCMS.

In some embodiments:
The graphical, textual or symbolic representation of the managed organization structure is based on the network physical layout.
The e graphical, textual or symbolic representation of the managed organization structure having additional logical view representation.
The graphical, textual or symbolic representation of the managed organization structure is synchronized with the organization's Directory Services.
The graphical, textual or symbolic representation of the managed organization structure can be mapped into an internal proprietary Directory Service.
The said synchronization with the Directory Services structure is being performed without modifying the Directory Services schema.
The said synchronization with the Directory Services structure is being performed with modifying the Directory Services schema.
The said organization's Directory Services are Microsoft/Novell/Unix or any other standard or proprietary Directory Service.
The said management and software deployment protocols can be configurable on per-node/s basis for TCP/IP Socket optimization such as port selection, timeouts . . . etc.
The said management and software deployment protocols can be configurable on per-node/s basis for bandwidth optimization.
The management and software deployment protocols can be configurable on per-node/s basis for Latency optimization.
The said management and software deployment protocols can be configurable on per-node/s basis for management and software deployment traffic compression to enable optimal network traffic utilization.
The said management and software deployment protocols can be configurable on per-node/s basis for management and software deployment traffic encryption to secure network traffic.
The said encrypted management and software deployment protocols are Secure Socket Layer (SSL) based.
The management and software deployment is done by single server instance.
The management and software deployment is done by multiple server instances.
The multiple server instances are arranged to support server Fault Tolerance.
The multiple server instances are arranged to support server Load Balancing.
The organization management representation enables viewing Real-time server(s) status and notifications.
The Real time view enables triggering of pre-defined and installable actions.
The remote management and software deployment activities are augmented by remote site server (Proxy components) which are used as mediators between Fast Connected LANs and Database Servers residing over slow network links. Site servers are responsible of: Serving as a software distribution point for the local LAN Thin Clients, confining the deployment traffic to the LAN, Filtering and scheduling outgoing client-information traffic sent from the LAN to Database Servers to reduce WAN traffic.
The said per node/s settings are Policy based.
The per node/s policies are also time and date dependant.
The said per node/s policies are also user dependant.
The said per node/s policies are also permission dependant.
The said per node/s policies are also device dependant.
The said directory service administrative permissions are Leveraged by the TCMS synchronization mechanism.
The said directory service administrative permissions are based on a proprietary permissions mechanism.
The said organization management representation enables viewing Real-time clients statuses and notifications.
The said Real time view enables triggering of pre-defined and installable actions.
The connection of a new client to the managed network is done by the following steps that can be set on per node bases: Said client has or receives valid management server parameters; TCMS authenticates that said client is a valid member of that organization; Upon negative authentication the TCMS can apply certain pre-defined settings and/or rules and/or policies; Upon positive authentication the TCMS can apply certain pre-defined settings and/or rules and/or policies and TCMS will map the client into the proper location or level within the directory service structure
The TCMS client connection process where authentication process is based on pre-configured unique client parameters such as MAC and/or GUID and/or IP and/or NAME and/or other.
The authentication process is based on manual administrator intervention.
The authentication process automatically authenticates the client based on its network location.
The authentication process is based on directory service authentication wherein the user installing that client is prompted to provide a valid Personal Identification Data (PID) that has permissions to install that new client.
The Personal Identification Data (PID) can be: User credentials and/or, passwords and/or, certificates and/or, voice recognition and/or, facial recognition and/or, finger print recognition and/or other biometric methods.
The authentication process is being redirected by TCMS installable component called Secured Authenticator (SA).
The plurality of SA's can be added to enable client authentication in front of plurality of security realms used by the organization.
The connection of a user to the managed network is done by the following steps that can be set on per node bases: User is prompted by said client to provide directory service Personal Identification Data (PID)
Said client securely transfers the supplied PID to the relevant TCMS SA; TCMS relevant SA communicates with the directory service to authenticate the supplied user PID; Upon negative authentication the TCMS can apply certain pre-defined settings and rules; and Upon positive authentication the TCMS can apply certain pre-defined settings and rules based on the user object location in the directory service.
The user authentication process is based on pre-configured user account that are applied automatically by the SA.
The user authentication process is based on directory service authentication wherein the user connecting at that client is prompted to provide a valid directory service PID that has permissions to connect.
The user authentication process is further augmented by hardware accessories authentication means such as smart-card, tokens, biometrics etc.
The plurality of SA's can be added to enable user authentication in front of plurality of security realms used by the organization.
The user authentication process its results and parameters may be exported to other predefined organization's systems to enable security and users management or other required functions.
The plurality of management parameters can be extracted from the system to be displayed and stored in plurality of log files.
The log can be configured to generate predefined actions and alerts.
The TCMS management console is implemented based on Web based GUI or any other remote published GUI.
The TCMS management console is implemented based on Microsoft MMC snap-in.
The TCMS management console is implemented based on Proprietary GUI.
The Database is Microsoft SQL and/or Access
The Database is Oracle.
The TCMS components further including one or more Managed Personal Computers (PCs).
The TCMS managed PC wherein the managed PC is further partially or fully converted to a thin-client functionality by modifying or replacing some of its operating system and local software components.
The plurality of installable software components, policies, utilities, new functionality, and server objects can be easily added after installation by modular components.
The function further includes the following utilities: Discovery tools: allows scanning TCP/IP networks using various protocols such as SNMP and/or HTTP and/or other; Import/Export Topology: allows importing/exporting a physical and logical topology into the TCMS; Import/Export Permissions: allows importing/exporting permission schemes at any level; Import/Export database content: allows importing/exporting the database content for backup and/or replication needs; Database Cleaner: allows reducing the database size by removing selected record types.
The plurality of management parameters can be extracted from the system to external third party applications such as Microsoft SMS 2003 and/or other applications.
The function further includes the following utilities: Hardware Inventory: device tracking by unique asset management information: such as ANY unique identifier as IP Address and/or GUID and/or MAC and/or Serial Number and/or NAME and/or Model version and/or other; Software tracking: provides installed and/or uninstalled software history details; Used software details.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

The invention will now be described in greater detail with specific reference to the appended drawing wherein:

FIG. 1 depicts PC client management system of the prior art.

FIG. 2 depicts Managed client structure of the prior art.

FIG. 3 depicts Hierarchical and logical structure of PC managed environment of the prior art.

FIG. 4 depicts Thin-client managed environment structure of the prior art

FIG. 5 depicts Mixed thin-client and PC managed environment structure of the prior art.

FIG. 6 depicts Typical TCMS thin-client managed environment structure according to an exemplary embodiment of the invention.

FIG. 7 depicts TCMS Hierarchical and logical structure of managed environment according to an exemplary embodiment of the invention.

FIG. 8 depicts Mixed TCMS thin-client and PC jointly managed environment structure according to an exemplary embodiment of the invention.

FIG. 9 depicts TCMS Policy application process simplified flow chart according to an exemplary embodiment of the invention.

FIG. 10 shows TCMS management console screen capture according to an exemplary embodiment of the invention.

FIG. 11 depicts TCMS console with farm manager screen capture according to an exemplary embodiment of the invention. FIG. 12 Depicts TCMS Site Protocol Settings tab screen capture according to an exemplary embodiment of the invention.

FIG. 13 TCMS FES Manager console screen capture according to an exemplary embodiment of the invention.

FIG. 14 TCMS Site Synchronization Manager screen capture according to an exemplary embodiment of the invention.

FIG. 15 TCMS Site Client events Manager screen capture according to an exemplary embodiment of the invention.

FIG. 16 TCMS Client Policy Editor screen capture according to an exemplary embodiment of the invention.

FIG. 17 TCMS Device policy security template screen capture according to an exemplary embodiment of the invention.

FIG. 18 TCMS Device Properties—Real-time tab screen capture according to an exemplary embodiment of the invention.

FIG. 19 TCMS real-time view of device related actions screen capture according to an exemplary embodiment of the invention.

FIG. 20 TCMS Device authentication provider properties page screen capture according to an exemplary embodiment of the invention.

FIG. 21 TCMS Authentication Properties tab screen capture according to an exemplary embodiment of the invention.

FIG. 22 TCMS screen capture of client attachment to domain according to an exemplary embodiment of the invention.

FIG. 23 TCMS Domain Authenticator Provider properties screen capture according to an exemplary embodiment of the invention.

FIG. 24 TCMS Domain User Authentication Provider properties screen capture according to an exemplary embodiment of the invention.

FIG. 25 TCMS Device and User Authentication Properties screen capture according to an exemplary embodiment of the invention.

FIG. 26 TCMS Installable Software deployment process simplified flow chart according to an exemplary embodiment of the invention.

FIG. 27 TCMS initial client connection sequence flow chart according to an exemplary embodiment of the invention.

FIG. 28 TCMS initial user connection sequence flow chart according to an exemplary embodiment of the invention.

FIG. 29 illustrates a configuration of the TCMS managed environment having at least one managed PC according to an exemplary embodiment of the invention.

FIG. 30 illustrates a TCMS managed environment according to an exemplary embodiment of the present invention, having additional administrative functions highlighted.

### DETAILED DESCRIPTION OF THE DRAWINGS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts.

The drawings are generally not to scale. Some optional parts were drawn using dashed lines.

For clarity, non-essential elements were omitted from some of the drawings.

As used herein, an element or step recited in the singular and proceeded with the word “a” or “an” should be understood as not excluding plural elements or steps, unless such exclusion is explicitly recited.

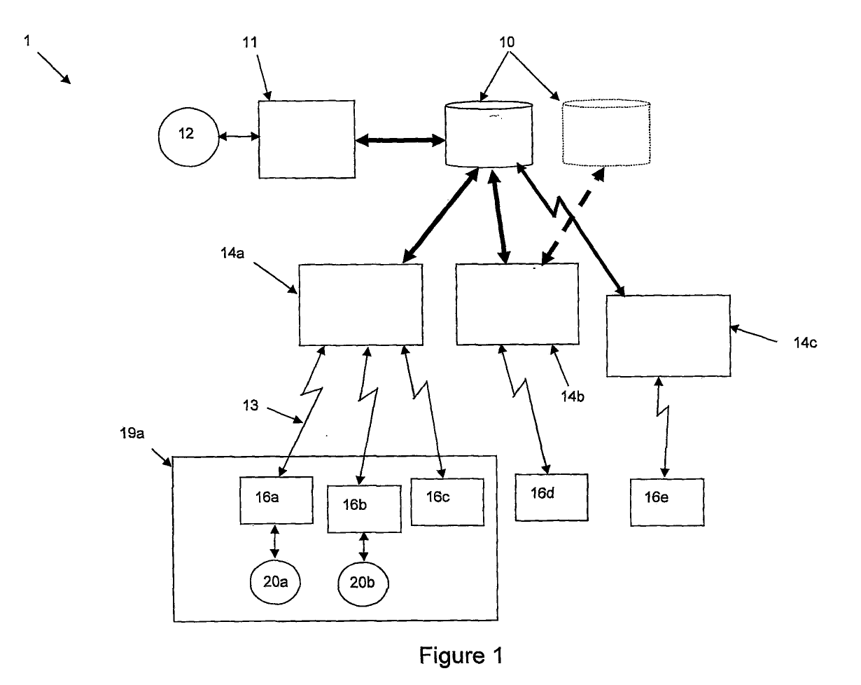

FIG. 1 illustrates a functional block diagram of a typical prior art PC client management environment 1. The system may be centrally located and managed or a distributed system with multiple sites and many managed clients. In a distributed system some or all management tasks are done from one or more centralized locations typically in a data-center or main branch.

Centralized data base 10 contains relevant management information such as managed device related information - device settings, organizational levels, device permissions, device status, device events log etc.

Data base may also contain user specific information such as user settings, user permissions and rights, administrative rights and events log. Data base typically representing a logical structure that resembles the physical or functional structure of the organization.

One or more administrator 12 uses a management console 11 to interact with the said data base 10 to execute daily management tasks such as adding devices, users, changing device settings etc. Typically the level of permissions that administrative users have in such system is also stored and managed by the said management system 1.

One or more Domain Controllers 14a, 14b and 14c positioned in a centralized location or co-located closer to the client, communicating with the said management data base 10 to retrieve and store required management data and distributed software. Domain Controllers are necessary in order to efficiently serve multiple managed clients 16a, 16b etc. located in local or remote sites. Such architecture enables redundancy and structured load management as clients 16x accessing respective Domain Controllers 14x and not the centralized data-base 10.

Management settings, commands and data sent to and from the management data base 10 via Local Area Network or Wide Area Network to the appropriate Domain Controller 14. From the Domain Controller 14x instructions or data are sent to the relevant managed Client 16x via Local Area Network or Wide Area Network 13.

Managed clients 16x typically communicating and managed by one Domain Controller 14x that logically or physically manages that managed domain. In case that one or more Domain Controllers 14 fails, managed clients 16 can access different (fall-back) Domain Controller if it can be accessed and if it can serve that client.

User 20a in this examples, uses client 16a and therefore may be managed by the system through Domain Controller 14a.

When user 20a logs-on to the environment 1, the user related information is pulled from the data base 10, delivered to the appropriate Domain Controller 14a and from there, through LAN or WAN link 13 it passed to the appropriate managed client 16a.

This typical managed environment illustrated in FIG. 1 is common in Microsoft, Novel and other widely used computer networks. It has many clear advantages over distributed management as it allows a disciplined and structured clients and user management with multiple management levels and reliable operation.

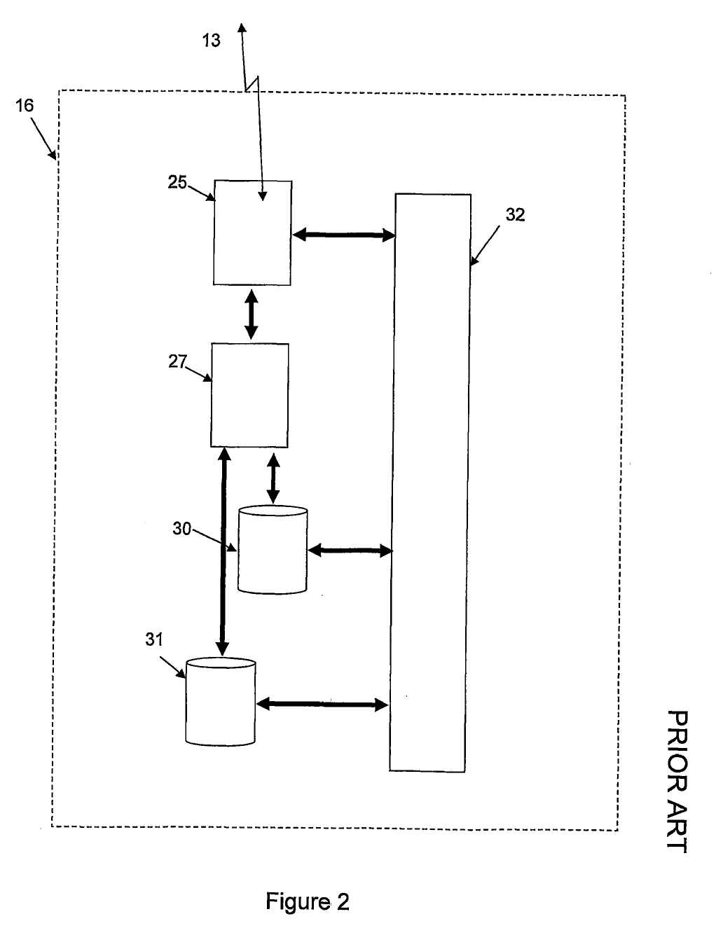

In order to implement the management environment shown in FIG. 1, the clients 16x need to be structured accordingly to interact with such system. FIG. 2 presents the typical managed client structure 16 to further illustrate the required management function.

In order to simplify the description, other non-management functions of the client 16 are not shown.

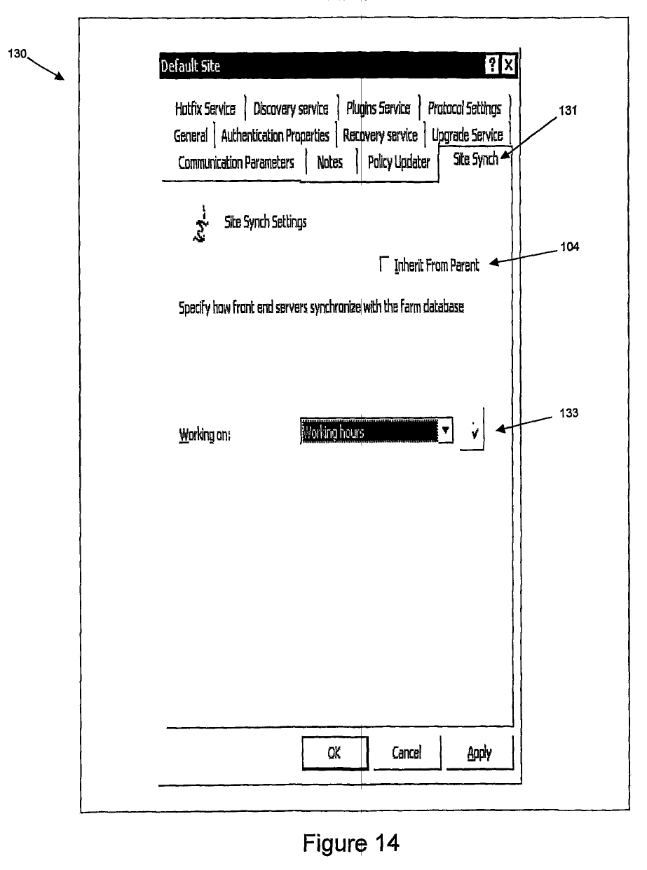

Referring now to FIG. 2, Managed client 16 is constructed of LAN or WAN link 13 that connects the client to the appropriate working and management network through LAN or WAN interface and stack 25. This LAN/WAN interface delivers the needed data to and from the managed device 16 via the LAN/WAN connection 13 and serves the client Operating System and applications 32 and the Management Agent 27. Management Agent 27 can be supplied with the Operating System (for example in Microsoft Windows XP operating system) or can be supplied by a different vendor as an add-on software (for example Altiris, HP OpenView and Tivoli management agents). The functions that the Management Agent perform are primarily to communicate and deliver management messages and components to and from the managed client 16 in synchronization with the Domain Controller shown in the previous FIG. 14. Management messages targeting the managed client 16 are received, parsed and mapped to the appropriate client local data bases 30 and 31.

Management Agent 27 loads data to and from the configuration data base 30 that contain the client state, settings and attributes. This data base 30 is sometimes called Device Registry. Some or all of the settings in this data base may be also managed directly by the client user/users if permitted.

In addition to the configuration data base 30, Management Agent 27 also loads installable software components into the client storage data base 31. This storage data base is then used by said client Operating System and applications 32 to execute installed programs. Management Agent 27 may also authenticate the client platform in front of the Domain Controller and authenticate the management servers or Domain Controllers in order to assure proper security level for the managed environment and its clients.

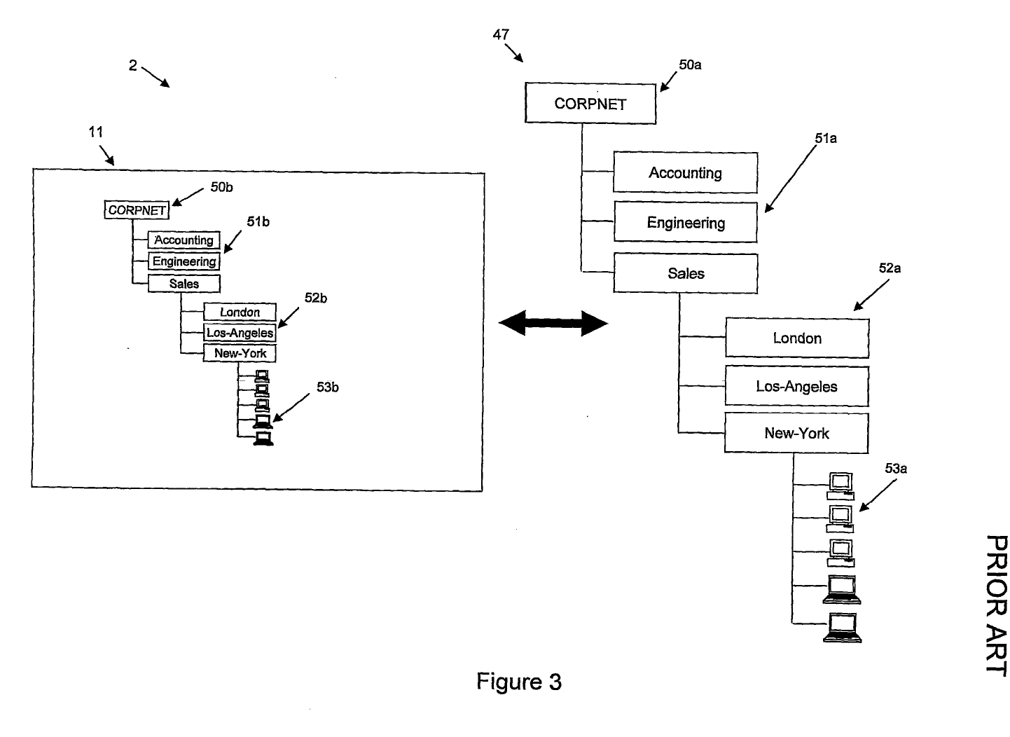

FIG. 3 illustrates the typical hierarchical logical structure of a PC managed environment 2 of the prior art. The organizational structure of the example shown is structured in multiple level tree. The right side 47 presenting the actual hierarchical organization structure while the left side 48 illustrates the administrator console 11 used to interact with the said management system.

The top of the tree (or directory service root) in this example is CORPNET, in the real organization view this top level shown in 50a; same level is shown in the administrator console 11 as 50b. Second level in the tree are three different departments: Accounting, Engineering and Sales marked as 51a in the organizational view and in 51b at the administrator console 11 to the left. Further in this example, under the Sales there is a third level marked as 52a in the organizational view and in 52b at the administrator console 11. This third level contains branches with the city location—London, Los-Angeles and New-York.

The forth level in this example contains the managed clients, 53b in the organizational chart and 53a at the administrator console 11.

This type of management console 11 reflects the actual hierarchical organizational structure and therefore greatly simplifies management tasks. It allows certain policies to apply on the whole tree or from certain level and downwards. This policy concept is crucial in managing large organizations as it allows superior control and security. One important feature of this system is the delegation capability. For example, if the global manager that manages the whole tree at 50x, delegates certain management tasks to New-York level administrators, the local administrators in New-York will be able to manage these settings or clients under their level 53.

This delegation concept is critical for large distributed organizations having multiple sites with multiple administrators.

It should be noted that managed objects 53a and 53b may be computers, servers, network equipment or even users. This combined management picture assists the administrators in their daily work performing tasks safely and efficiently.

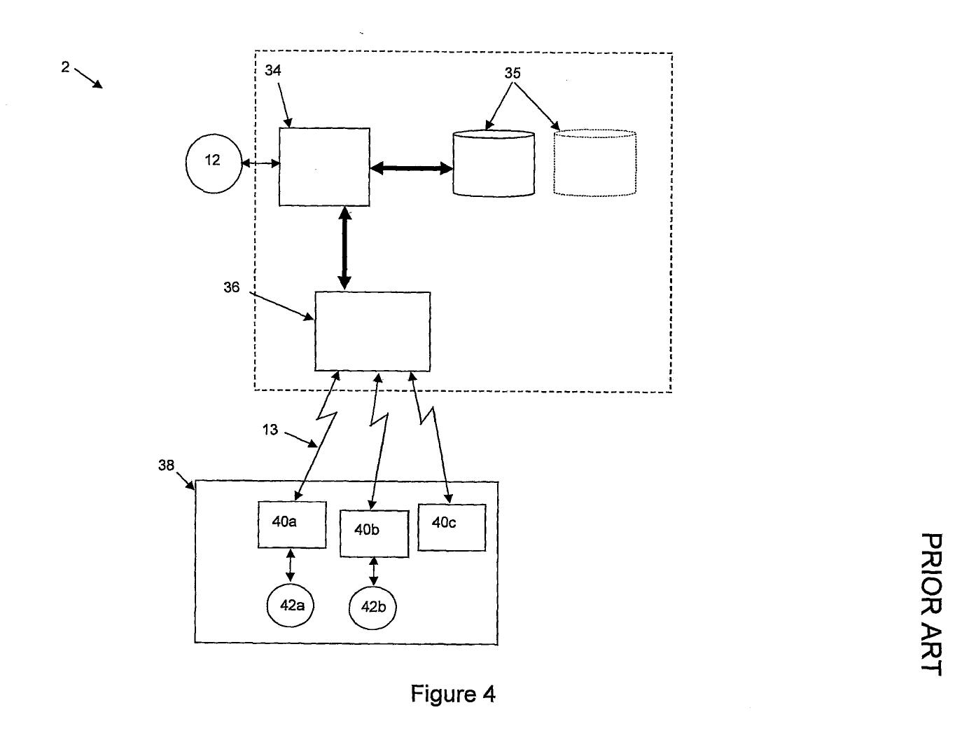

Referring to FIG. 4 a typical thin-client management system and environment 2 is illustrated to serve as a reference for the present invention. The typical management system and environment is typically consisted of one or more management data base 35 storing all relevant management information for that environment. A Management console 34 to interact with the said data base 35 and to communicate with the management servers 36. Data base 35 may interact also with the Management Servers 36. Administrator 12 can interact with the said management system through GUI presented in a web interface or other forms. Typical management tasks are performed using special scripts and short programs written and manipulated by said administrator 12.

In a typical prior art management systems there is only one management server 36 and this makes the system prone for reliability and availability problems.

Management server 36 typically connects through LAN or WAN link 13 to the managed thin-clients 40x located in local or remote location 38. User 42a uses the thin-client 40a and connected to the Management server 36.

Comparison with FIG. 1 showing a prior art PC client managed environment may present many similarities, but still there are many important differences between these two environments and many of them resulting major disadvantages with the prior art thin-client managed environment. The fundamental differences and disadvantages of the system shown in FIG. 4 can be further highlighted if we would consider the integration of that environment with the common PC managed environment shown in FIG. 1. This integration between the PC and the thin-client managed environment is critical as many organizations deploying mixed environments.

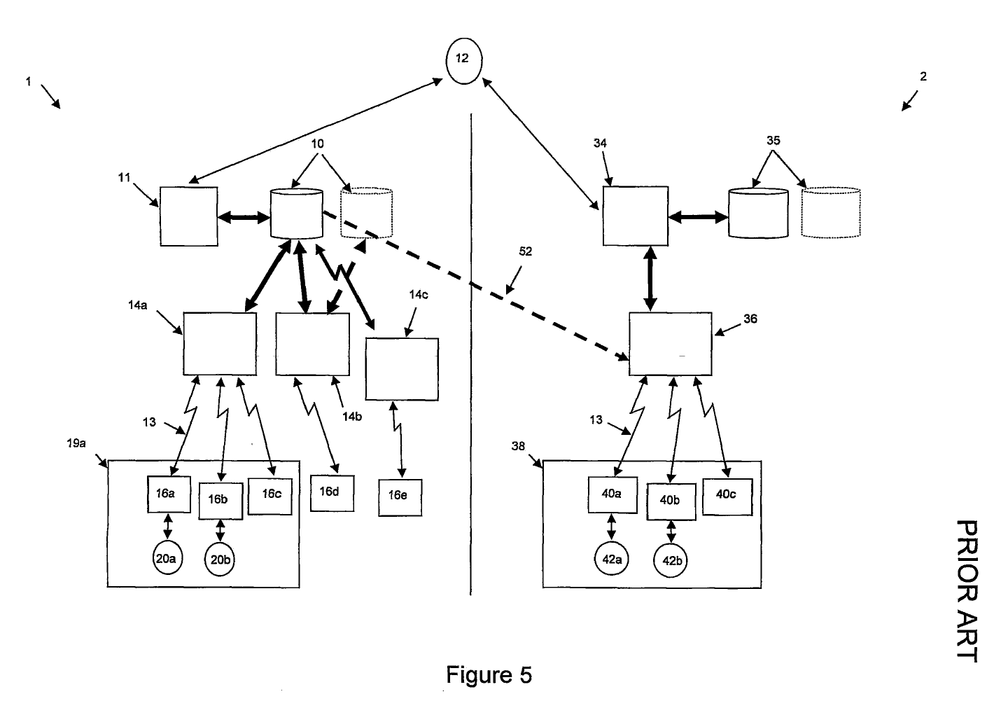

FIG. 5 illustrates the typical managed thin-client environment shown in FIG. 4 above, together with the PC managed environment showed in FIG. 1 above.

On the left side managed PC environment 1, managed PCs 16x are linked to their respective Domain Controller 14x through LAN or WAN connection 13. Domain Controller 14x connected to the management data base 10. The administrator 12 can interact with the system using PC management console 11.

On the right side managed thin-client environment 2, managed thin-clients 40x are linked to the management server 36 through LAN or WAN connection 13. Management server 36 connected to the management data base 35. The administrator 12 can interact with the system using separate thin-client management console 34.

As there are fundamental differences between the presentation and the structure of these two systems, the administrator cannot interact with a single system. This lack of integration causes many operational problems that can be easily overcome by the present invention as will be described bellow.

It should be noted that some prior art thin-client management solution (like Chip PC's Xcalibur XP product) can synchronize with the PC management data base 10 through a synchronization program or agent 52. This agent or service typically initiate an LDAP query to the PC management data base 10 to get required device or users information. While this solution may assist in the administrative tasks, still it is very limited and provides very little visibility of the processes and results.

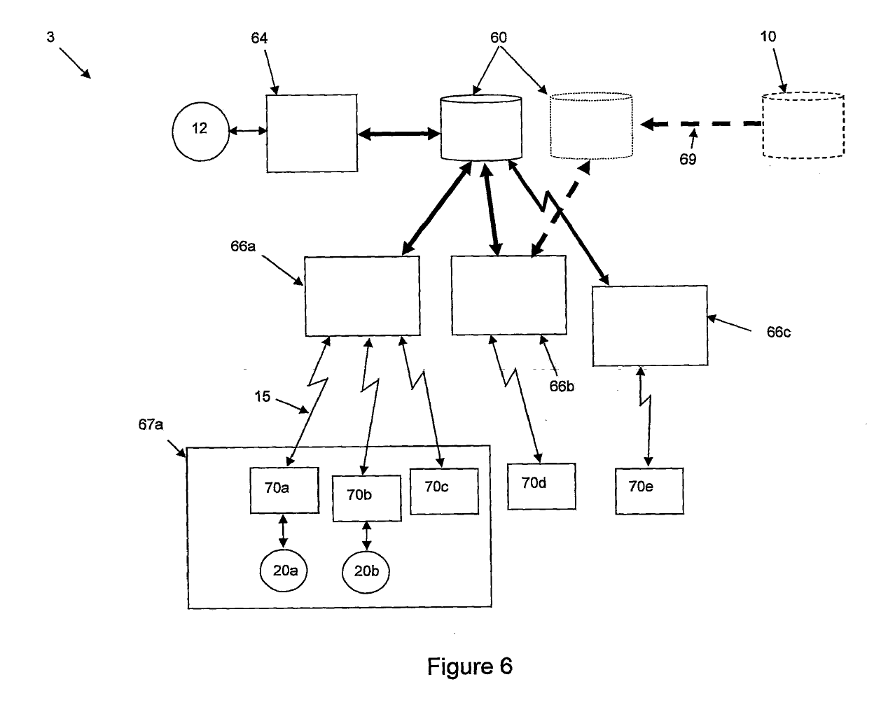

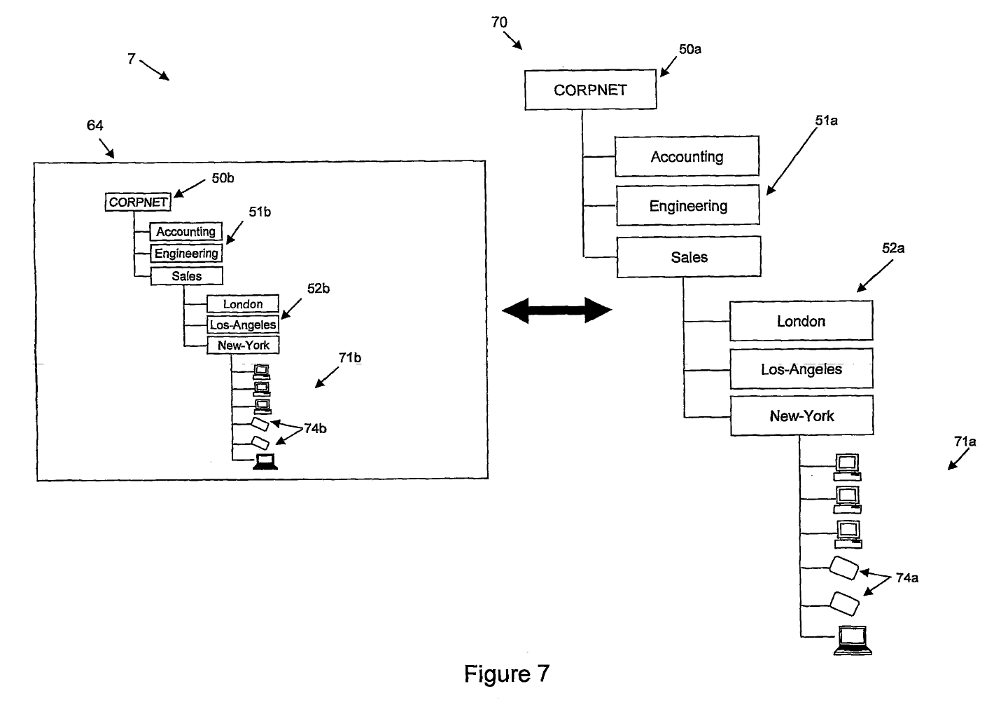

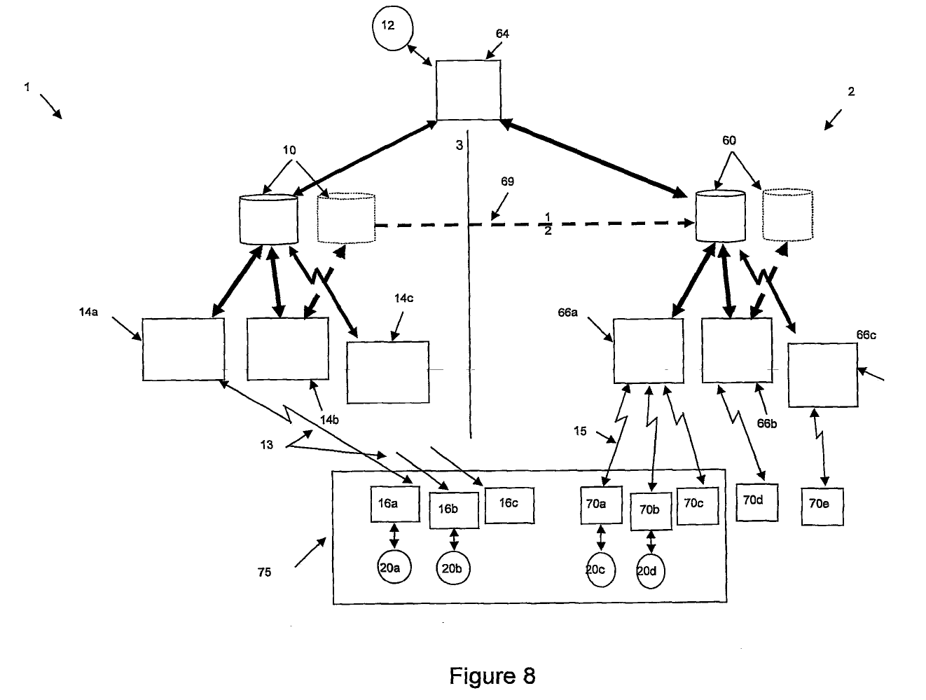

Referring now to FIG. 6, a managed thin-client environment 3 of the present invention is schematically described.

Data base 60 contains the management data required to manage the relevant thin-clients. Data base 60 can be of any type available such as Microsoft SQL, Oracle, DB2 or any other standard or proprietary type. Data base 60 can be mirrored at one or multiple sites to enable system redundancy and high availability.

It should be noted that data base 60 is typically a separate data base than the organization PC management data base 10.

This separation characteristic is typically desirable to avoid changes in the existing schema. This separation may also be used if thin-clients management is used in an isolated environment where no PC directory services available or needed. It can also be used in order to run of a proprietary data base if needed. However in some cases, it may be possible or necessary to integrate these two data bases together into a unified data base.

A one sided read operation 69 is implemented in a typical TCMS setup to query the PC management data base 10 and to synchronize at a periodical period the thin-client data base 60 accordingly.

Said data base 60 linked to the local or remote administrator TCMS console 64 to enable administrator 12 interaction and management tasks. It should be noted that there may be one or multiple administrators 12 at any management level and any location as needed by the organizational structure.

Data base 60 is further linked to one or more Front End Server (FES) 66a, 66b, 66c etc.

These said FESs acts as interface and proxy between managed thin-clients 70x and centralized data base.

Managed thin-client 70a located at site 67a is linked to FES 66a to get policies settings and installable software components. Client 70a can deliver status and state messages, various settings etc. back to the respective FES 66a and then to the centralized data base 60. Administrator can interact with managed thin-client 70a through the appropriate settings and data in the centralized data base 60.

Again it should be emphasized that the TCMS enables multiple FESs to co-exist and provides fail-safe structure for high-availability. Communications between the FES 66a and the managed thin-client 70a can be done over LAN or WAN 15 using unencrypted or encrypted protocols. This encryption option enables higher system security and preventing service attacks or cloning of clients and servers.

FES can be located centrally or off-site as shown in the figure by FES 66e. This FES is co-located off site to enable closed link with managed thin-client 70e. This arrangement can improve management and software deployment performance in real-life limited bandwidth scenarios. In this scenario, communication link between FES 66e and the centralized data base 60 may be frequently interrupted or low bandwidth and therefore client 70e and FES 66e can be positioned on the same LAN to achieve good connectivity. Software components need to be deployed on client 70e and other clients at that remote location can receive the needed components on the LAN from the local FES 66e even if the current communication with the centralized data base 60 is limited or not available.

Referring to FIG. 6 illustrates and example of TCMS Hierarchical and logical structure of a mixed managed environment 7. At the right side the physical structure of the organization 70 is shown while on the left side the TCMS management console representation 64 is shown. The organization shown in this example is similar to the one showed in FIG. 3 above only in this case the managed environment includes a mixture of PCs and thin-clients 74a and 74b.

Managed objects shown in the organization structure 70 including 2 thin-clients 74a and other managed objects. On the TCMS view shown in the left side 64 the two managed thin-clients are shown inside the appropriate managed tree 71b. This integrated view of the managed thin-clients 74x together with other managed objects is a key feature of the current invention. Administrator can apply special thin-client policies on managed thin-clients according their position on the main management tree. There is no need to duplicate or replicate management tree as everything is combined into one management tree. In the of Microsoft management environment for example this console 64 is a snap-in to Microsoft Active Directory MMC. Similarly a modular TCMS console 64 can be added to Novel NDC or other hierarchical management tools to provide similar integrative functionality.

To better illustrate this integration, see FIG. 8. In this figure a mixed thin-client environment 2 and PC environment 1 are jointly managed through TCMS integrated management scheme. Thin-clients 70a, 70b and 70c and PCs 16a, 16b and 16c are jointly located in site 75. Thin-client 70a connected over LAN or WAN link 15 to FES 66a that may be locally ore remotely located. FES in turn communicating with the TCMS data bases 60 over LAN or WAN. In a similar manner PC 16a connected over LAN or WAN link 13 to the appropriate Domain Controller 14a. Domain Controller 14a connected over WAN or LAN to a local or remotely located management data base 10.

Read only synchronization of the TCMS data base 60 with PC management data base 10 is periodically accomplished by service 69. Typically no information is written by TCMS on the PC management data base 10.

Unified management console 64 presents the administrator 12 with a single integrative picture of the managed thin-clients and other managed objects under his/her control.

This unified structure enables the administrator 12 to apply Group Policies or special TCMS policies on specific or all managed thin-clients. Typically the TCMS console 64 does not enable the administrator 12 to perform management tasks on PCs or other managed objects.

It is important to note that administrator 12 may use TCMS to manage TCMS resources such as FESs and data bases.

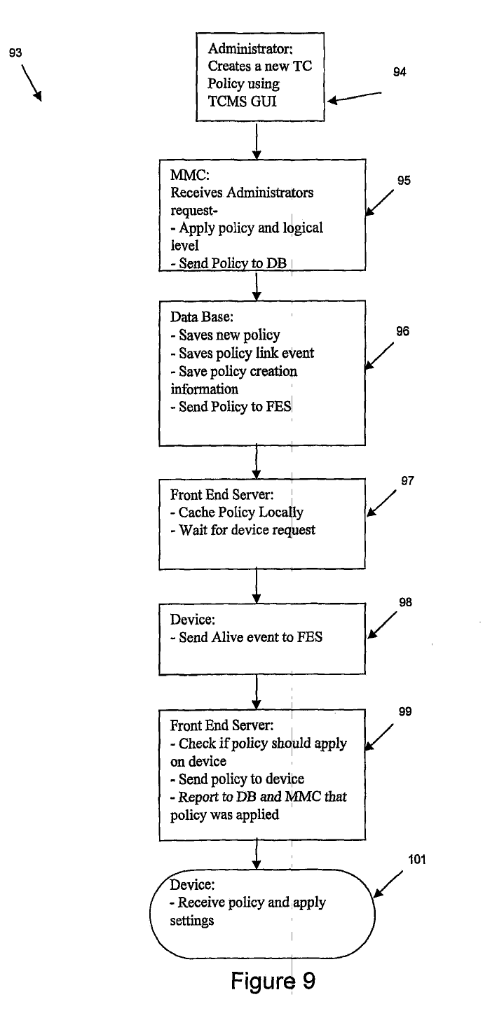

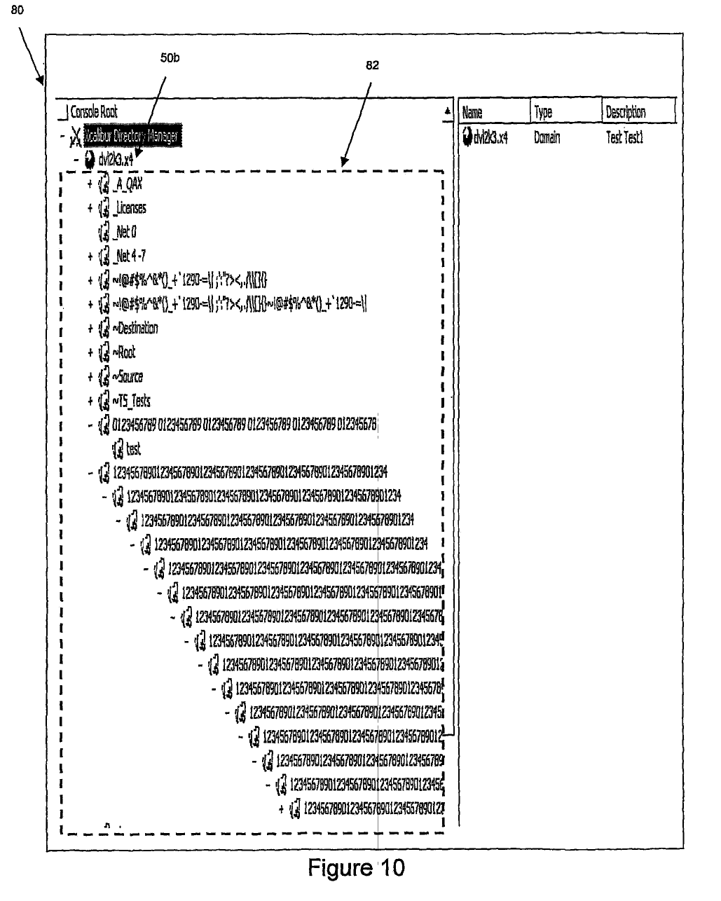

FIG. 9 provides a simplified flow chart 93 of TCMS events sequence when administrator apples policy on a managed thin client device.

Events sequence starts when administrator creates a new TC Policy using TCMS console at step 94. As a result the TCMS data base receives and saves new policy, saves policy link event for logging purposes, save policy creation information and finally sends the policy to the FES (step 95). In step 96 the Front End Server cache the received policy locally (step 96) and then waits for device request to trigger policy delivery. At step 97 when device send Alive message to the FES checks if policy should apply on device (step 99). If positive then at step 98 the FES sends the policy to the device and reports to the data base and to the MMC that policy was successfully applied. At last in step 101 the device applies the policy locally to enforce required change or setting. In a similar manner installable software instead of policy can be deployed to the managed client.

FIG. 10 depicts a screen capture of the TCMS management console 80. In this figure the Directory Service Root 50b is the top level. Multiple level object containers 82 contain the managed object structure in the organizational tree structure.

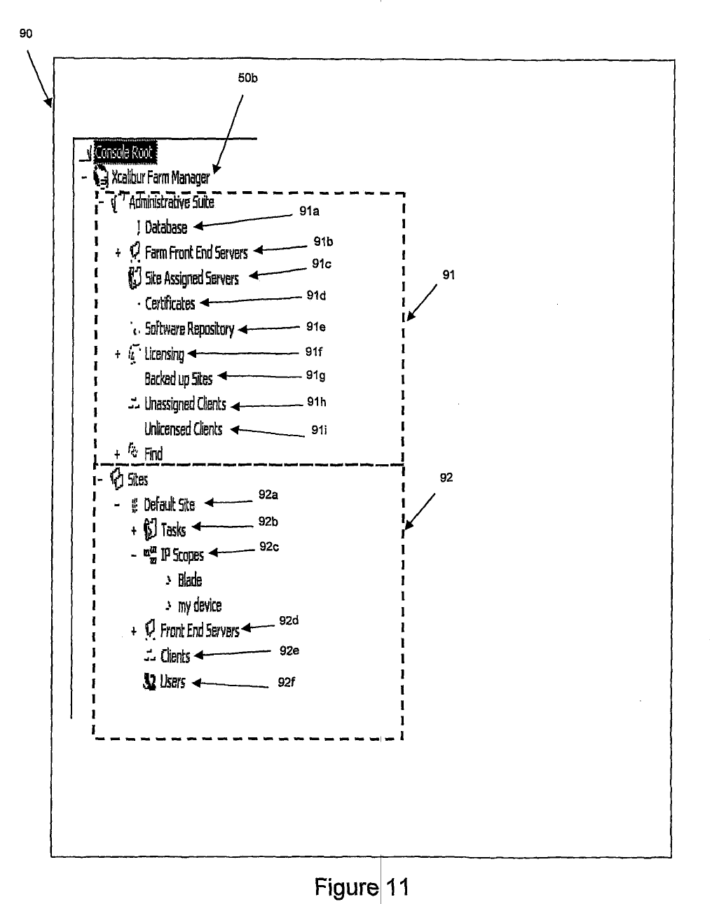

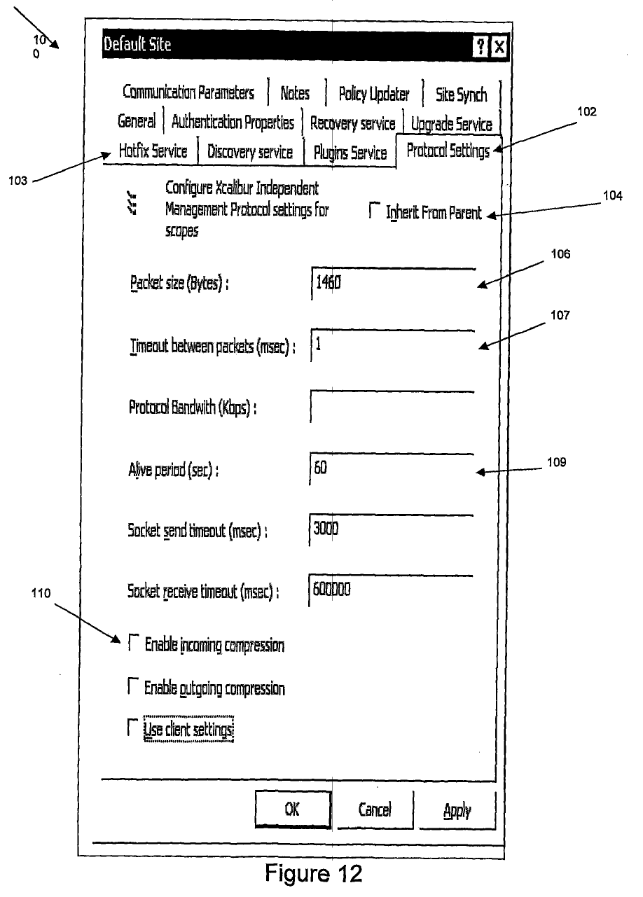

FIG. 11 depicts a screen capture of typical TCMS console 90 with TCMS farm administrative area 91 and Sites and IP scopes management area 92 visible. Farm administrative area 91 contains icons that represents managed TCMS infrastructure objects such as: TCMS data bases 91a, TCMS Front End Servers 91b, Site assigned servers 91c, Certificates for management tasks authentication 91d, Software repository 91e containing client software components for distribution, Licensing icon 91f containing client licenses for various software applications, backup sites 91g containing access details for alternative backup sites for management, Unassigned clients 91h containing clients that were not assigned to connect to a specific organizational unit in that tree and Unlicensed clients 91i containing the group of thin-clients detected but that are unlicensed to be managed by the TCMS.

Sites and scopes area 92 contains accessible icons 92x related to that specific site. This area contains icons for site name 92a, tasks folder 92b containing relevant management tasks for that site 92a, IP Scopes 92c containing managed clients IP ranges, Front End Servers 92d containing the site assigned FESs, Clients 92e containing the clients assigned to that site and Users containing the regular users and administrative users assigned to that site. Typically the administrative rights to manage TCMS clients are inherited and identical to the PC management rights in the PC management system.

FIG. 12 presents a screen capture of TCMS Site Protocol Settings tab 100. This tab is one of several user selectable tabs 101 to enable efficient administration of sites and sites specific characteristics. The Site protocol enables settings of the desired management protocol characteristics to match each particular site. A Check box INHERIT FROM PARENT 104 enables user selection of inheritance from higher level or user defined settings from that level and downward. Packet size input field 106 enables user selection of maximal packet size to optimize management traffic for specific site network link characteristics. Time out between packets input field 107 enables local caching of management traffic for short pre-defined period to reduce the frequency of short management traffic bursts.

Alive period input field 109 enables user setting of the time interval between clients to FESs alive message. This setting is also essential in order to reduce short traffic bursts and hence to reduce WAN traffic.

Enable Incoming Compression check box 110 allows the user to define management traffic compression to and from the client. The use of traffic compression reduces the WAN loading if bandwidth is limited.

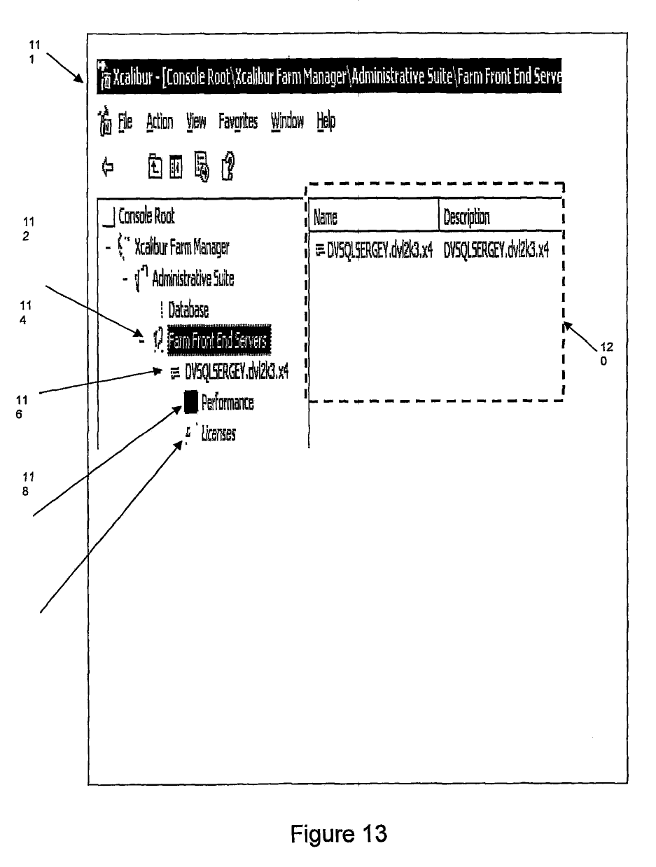

FIG. 13 showing a screen capture of TCMS FES manager 111. In this figure the following icons are visible inside the specific FES container 114—FES Performance monitor 116 containing current server performance parameters for that FES and Licenses container 118, containing required FES management software licenses. Area 120 contains details about the one ore more EFSs contained in that specific farm container 112.

FIG. 14 depicts a screen capture of TCMS Site synchronization management tab 130. This tab enables the administrator to define the characteristics of the site FES/s synchronization with the data base. Working on input field 133 enables administrator selection if synchronization will occur during working hours or off-working hours. Synchronization off-working hours enables bandwidth utilization by users and application at peak time while performing demanding synchronization off-working hours.

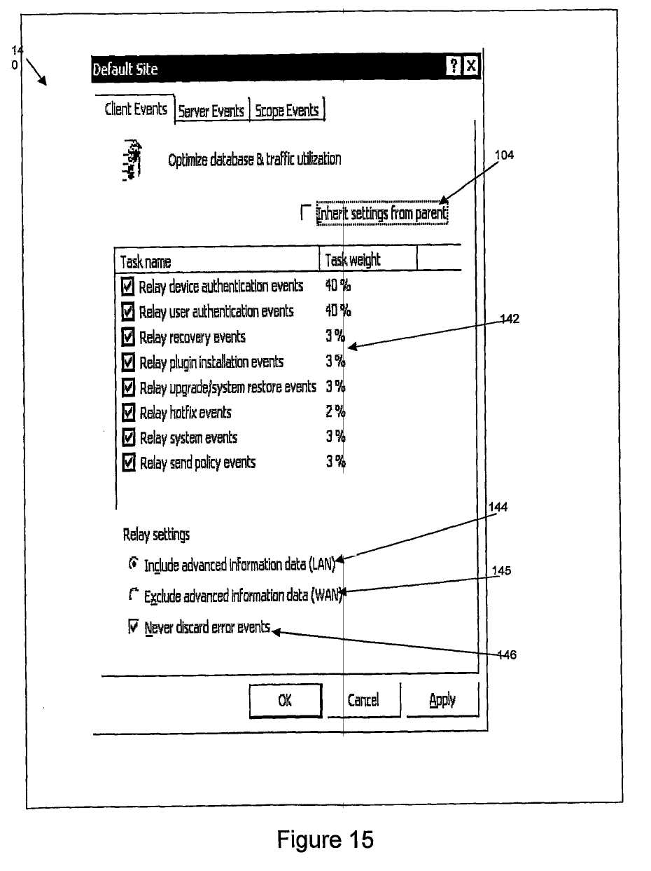

FIG. 15 illustrates TCMS Site Client Events Manager tab screen capture 140. The task weight input table 142 enables the administrator to decide and set the relative importance of specific reported client events to avoid network saturation. This setting is important in limited WAN environment to maintain proper monitoring of client events. Additional check boxes 144 and 145 enables inclusion and exclusion of additional event messages to further reduce management traffic in WAN environments. The NEVER DISCARD ERROR EVENTS check box 146 enables the administrator to prioritize error events over any other reported events.

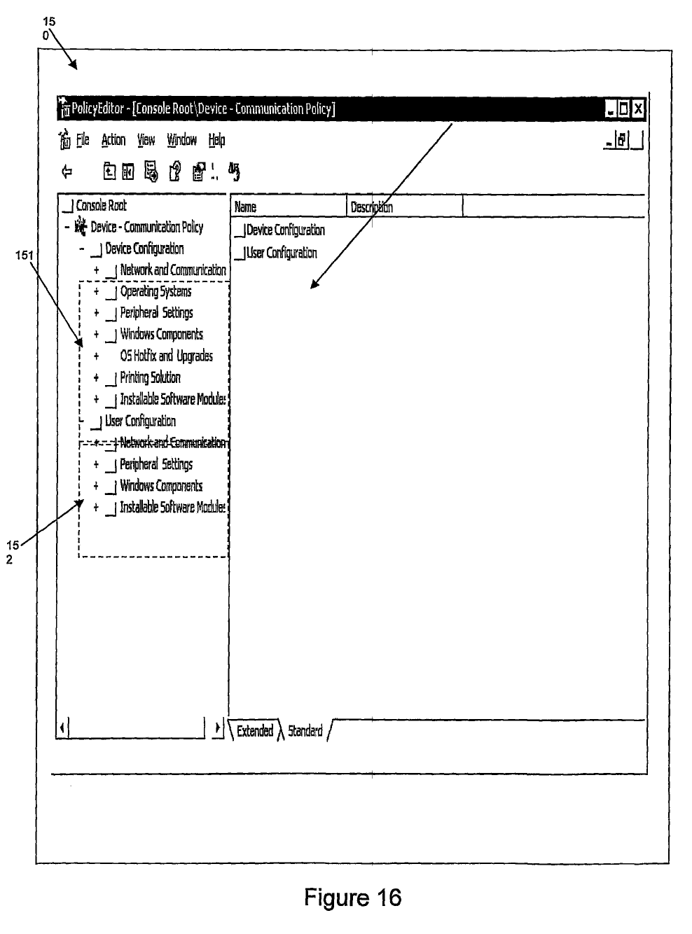

FIG. 16 presents TCMS Client Policy Editor screen capture 150. This tab enables policy settings for specific device (client) or devices.

The device configuration policy container 151 contains device specific settings such as Network and Communications settings, Operating System settings and Peripheral settings. This container also includes the Installable software modules intended for distribution to the client/s.

User configuration policy container 152 contains user specific settings similar to the device settings. This enable user roaming settings and even user triggered software deployment model.

The table on the right side 155 provides details on each contained policy.

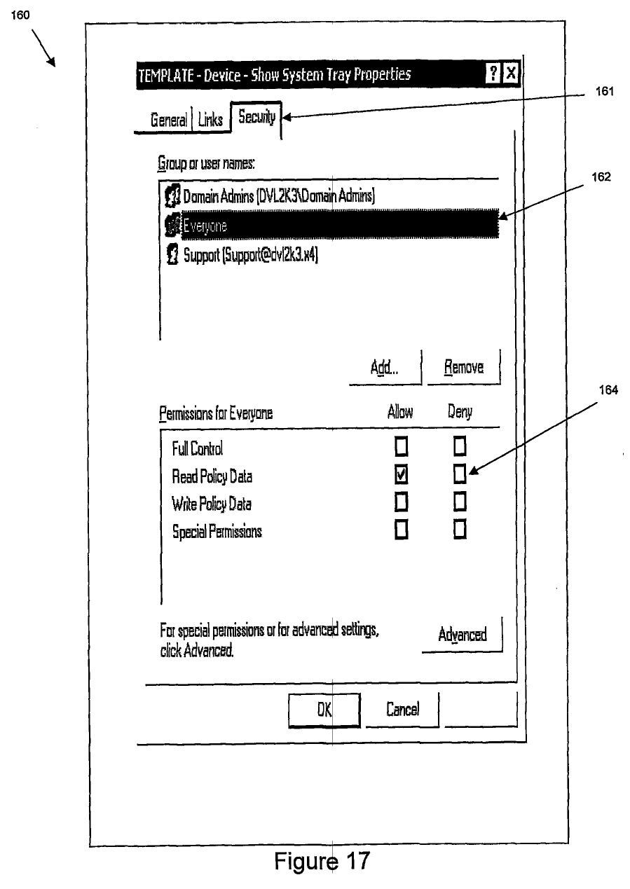

FIG. 17 illustrates TCMS Device Policy security template screen capture 170. This template enables the administrator to define the different administrative rights of certain users groups. For example in this figure the permission to read (not change) system tray settings policy for devices is provided to everyone 162. Other type of defined users may have different permission levels as needed.

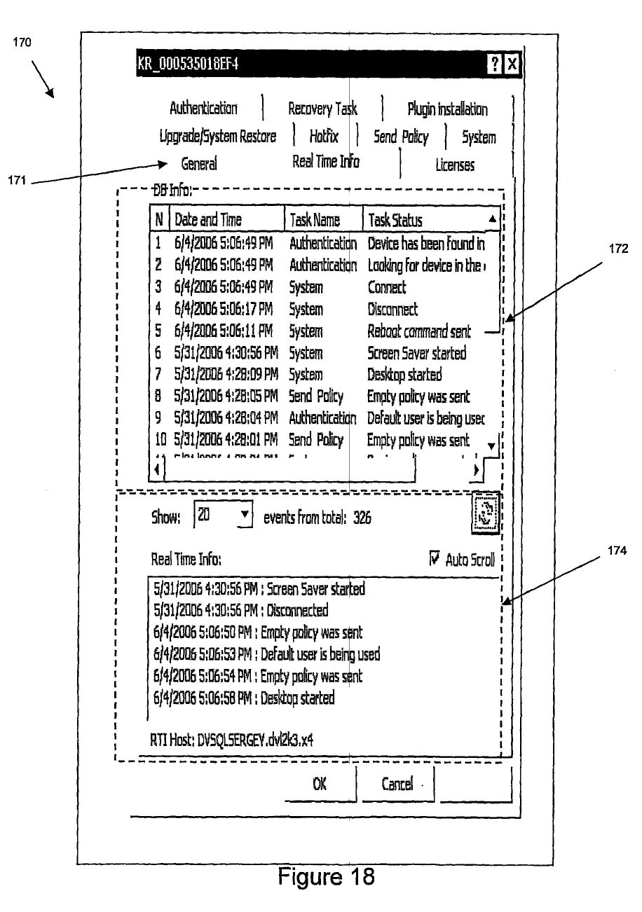

FIG. 18 illustrates TCMS Device Properties—Real-time tab screen capture 180. This tab presents relevant device events log at the upper area 172 with device tasks and events description, time and date and task status. In the lower section 174 there is real-time information window showing device related real-time events. Administrator can scroll upwards to browse past events.

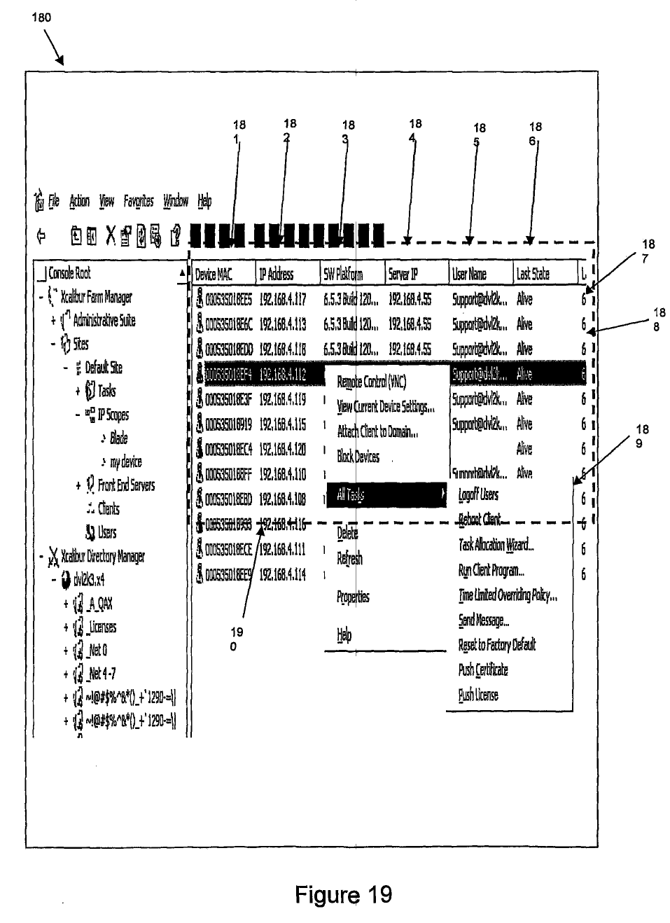

FIG. 19 illustrates TCMS real-time view of device related actions screen capture 190. This screen enables administrator to view real-time information about current IP Scoop clients. Table 190 can be sorted by different columns such MAC Address 181, IP address 182, Image software platform version 183, FES IP Address 184, Logged user name 185, and Last state 186. Many other columns containing further client information can be presented and sorted. Selected client line 188 enables the administrator to select between the different available actions for that device 189. This includes logging of user, reboot option, send message etc.

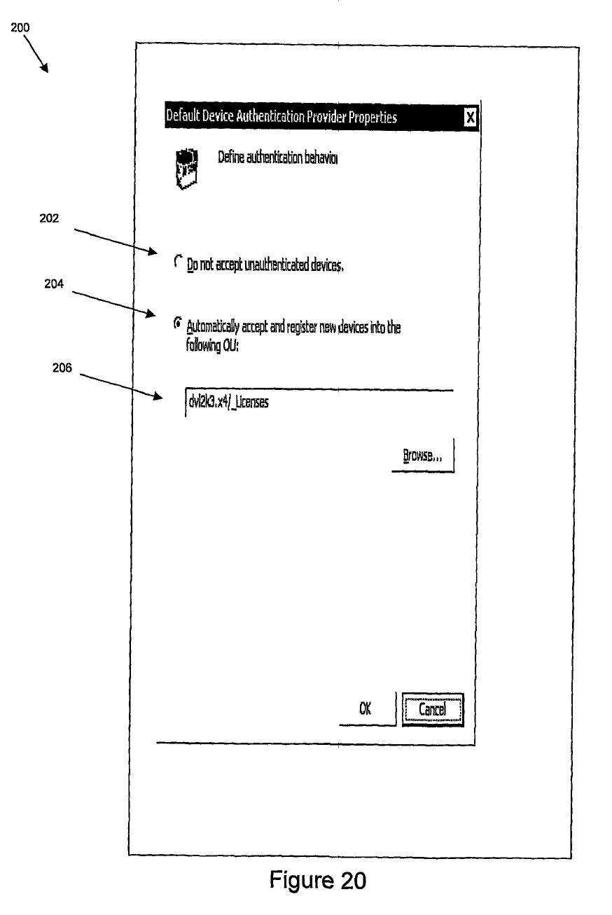

FIG. 20 presents TCMS Device authentication provider properties page screen capture 200. This page enables the administrator to define the system device authentication behavior. Check box 202 enables rejection or acceptance of unauthenticated devices into the managed network. Input box 204 and field 206 enables entering a default OU for new authenticated clients. The policy of that OU may be very restrictive to enhance system security.

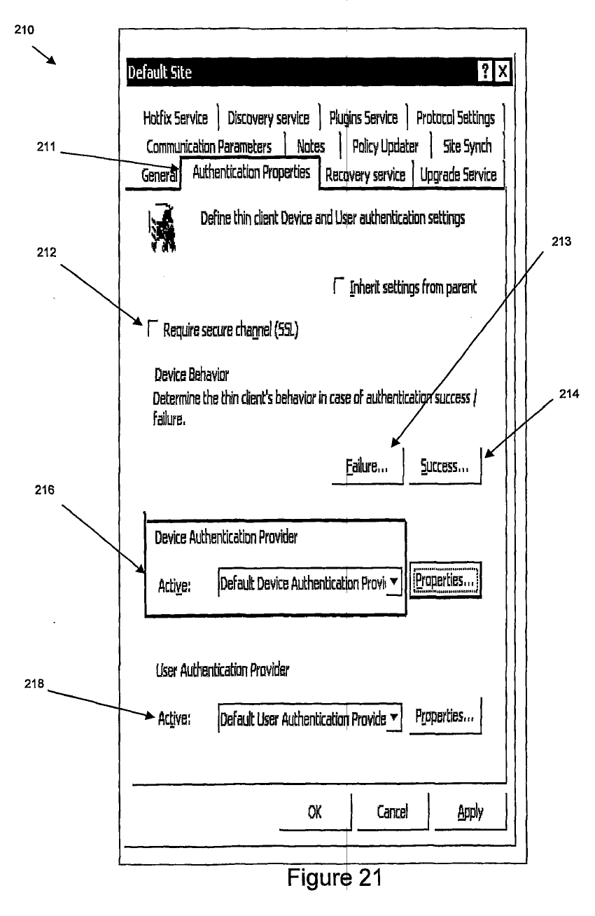

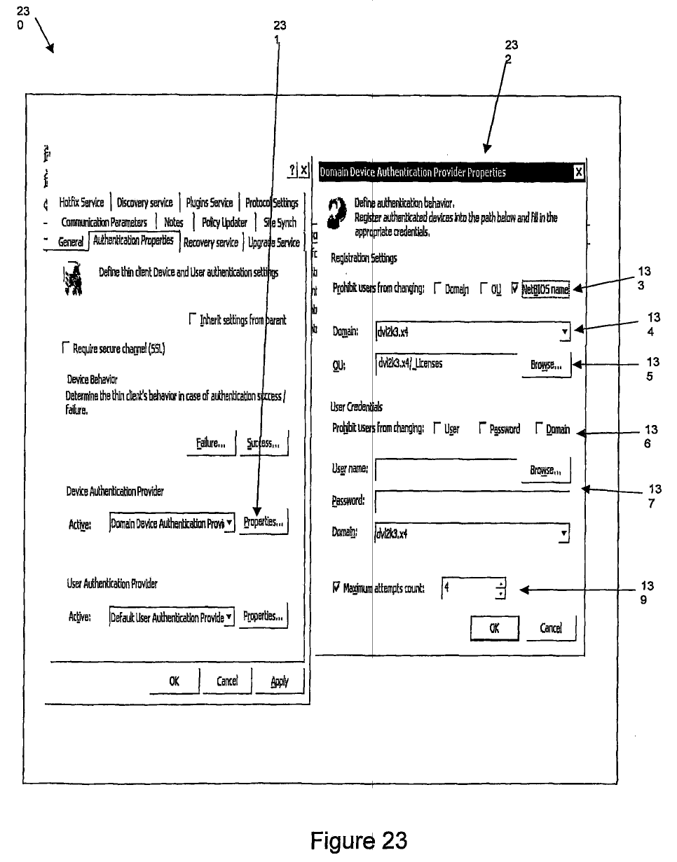

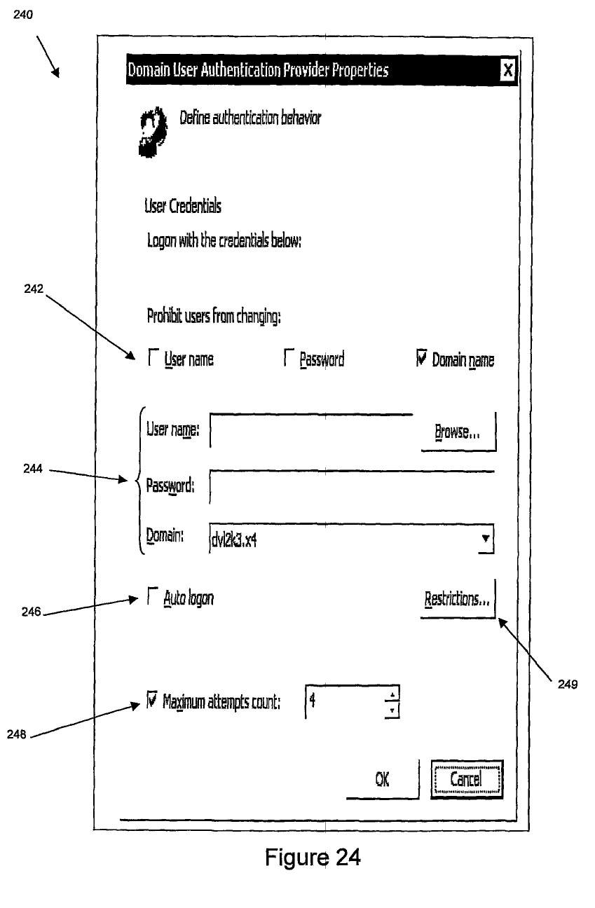

FIG. 21 presents TCMS Authentication properties tab screen capture 210. This page (211) enables administrators to define device authentication behavior. Check box 212 enables administrators to require clients to connect to the TCMS using secured communication protocol. Check boxes 213, 214 help administrators to determine device behavior if the authentication succeeded or failed. Combo box 216 enables administrators to define weather to use default device authentication as described in FIG. 20 or to use domain device authentication as described in FIG. 23. Combo Box 218 enables administrators to define weather to use default user authentication or Domain user authentication as described in FIG. 24.

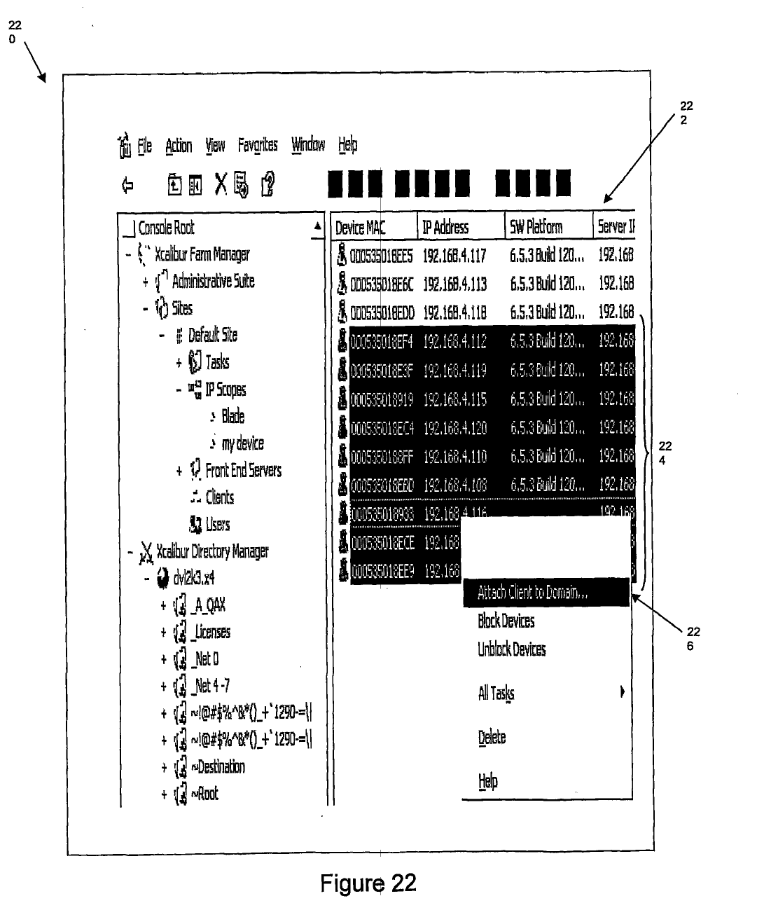

FIG. 22 presents a screen capture 220 showing how managed clients can be manually attached to the directory service root or any child container. Table 222 shows a list of clients assign to any physical level in the TCMS. List 224 present clients selected by the administrators. Option 226 enables the administrator to attach those clients to the directory service root or any other container.

FIG. 23 presents domain device authentication properties dialog as seen in screen capture 230. This dialog is used to enable end-user to attach their TC to a Directory Service container. Using credentials provided by them or by the administrator. Button 231 will open the properties dialog as seen in screen capture 232. Check boxes marked as 133 enable administrators to prevent end-users from changing their directory service location information. Combo boxes 134, 135 are used to enable administrators to set or suggest directory service root and container. Combo box 137 is used to specify user credentials to check for directory service permissions. Check box 136 is used to prevent end users from changing credentials set by administrators.

FIG. 24 presents the domain user authentication properties dialog as seen in screen capture 240. This dialog is used to configure user level restrictions and limitations. The check boxes marked as 242 are used to prevent users from changing predefined authentication credentials. Text boxes 244 are used to force or to suggest certain credentials to be used by end users. The Auto logon check box (246) is used to pass the assigned credentials without user's conformation. Check box 248 “Maximum attempts count” is used to define the number of allowed log-on mistakes. Button 249 is used to create domain and suffix restrictions on the end user log-on.

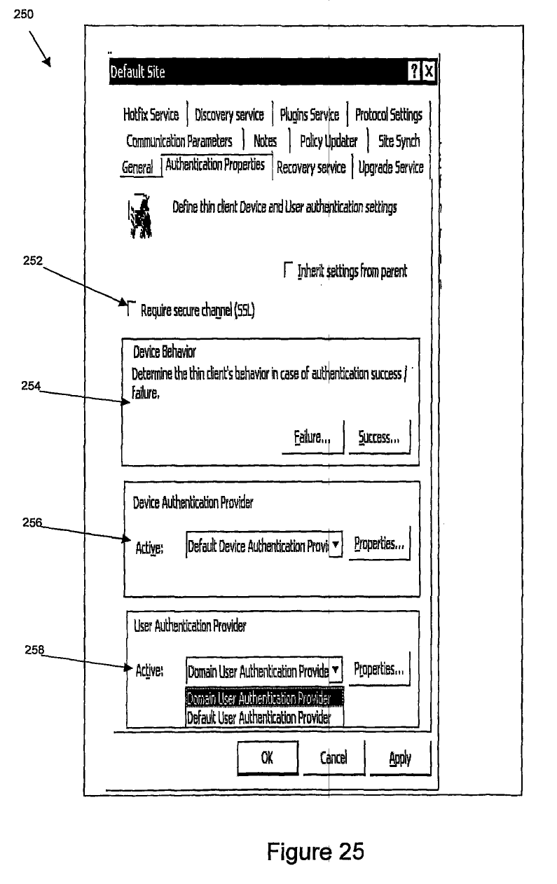

FIG. 25 presents the site synchronization settings dialog as seen in screen capture 250. Used to configure when Site FES will receive and send information to TCMS data base. Use check box 252 to define if settings for this dialog should be received from parent object. Use combo box 254 to define when will synchronization happen (always, never, manual control, working hours).

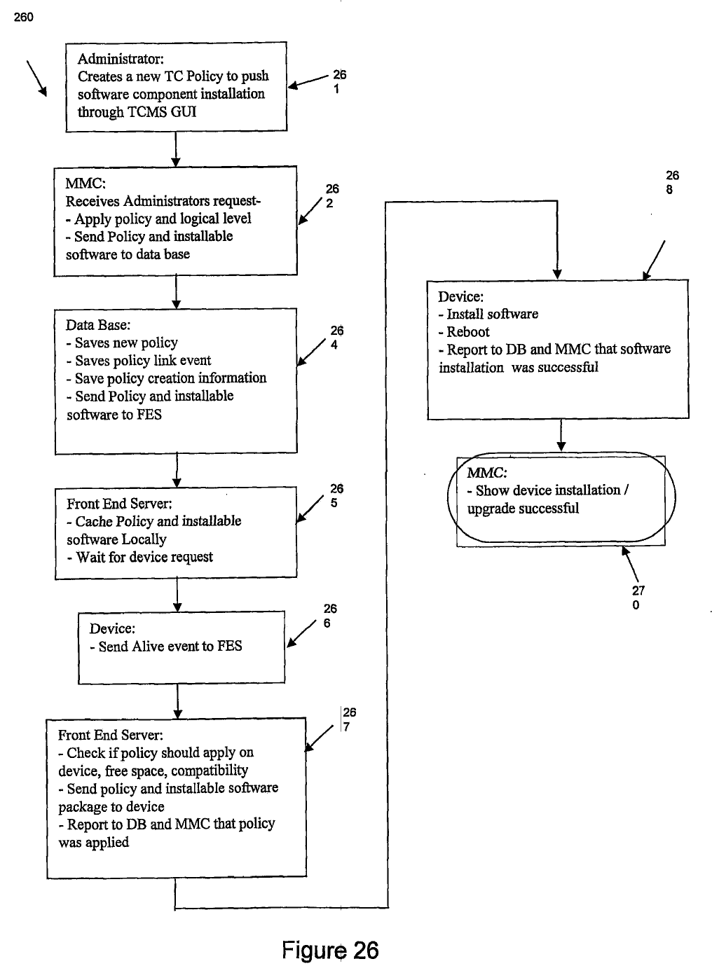

FIG. 26 described software deployment process to TC devices as seen in diagram 260. Block 261 includes administrator's actions that creates the new software deployment policy and defines device installation location and settings. Block 262 describes MMC behind the scene actions: Policy is applied on a logical level, Policy is sent to data base, The MMC checks for directory service permissions. Block 264 presents data base operations. The policy is saved in the TCMS data base, the policy link event is saved as well along with the credentials of the user who created or linked the policy. Block 265 describes FES operations: cache policy locally. The device sends an alive event to front end server as described in block 266. Alive event period can be set on any physical or logical level. Once the FES receives the Alive event the FES checks if the policy should apply on the device based on its logical location and permissions. If the policy should apply on the device the software component along with installation instructions are sent to the device as seen in Block 267. The device reports the software installation progress and perform reboot (if necessary) as seen in block 268. Administrators can see the software deployment progress on a single or multiple devices using MMC (270).

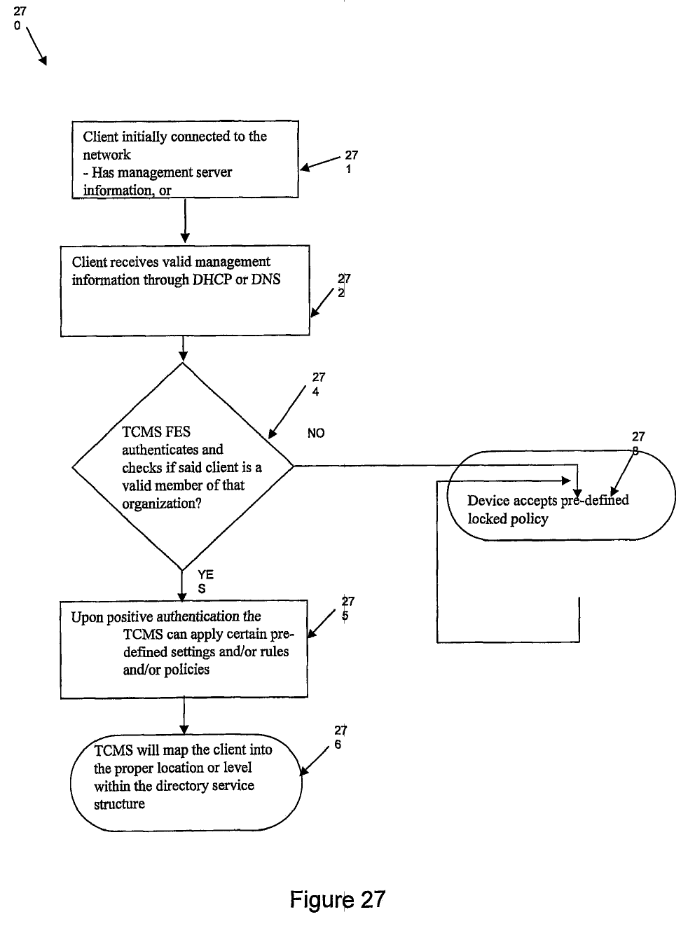

FIG. 27 present device initial connection and authentication sequence as seen in simplified flow-chart 270. The process described enable passing TCMS location and communication settings to client, map client to a proper logical location, and prevent unauthorized clients from connecting to the organization's network. Blocks 271 and 272 describe how device receives TCMS location information. Authentication, as defined in block 274, can be performed using predefined lists, credentials, biometric information etc. Once the client is authenticated it will be registered to a logical location and receive predefined settings as described in block 276.

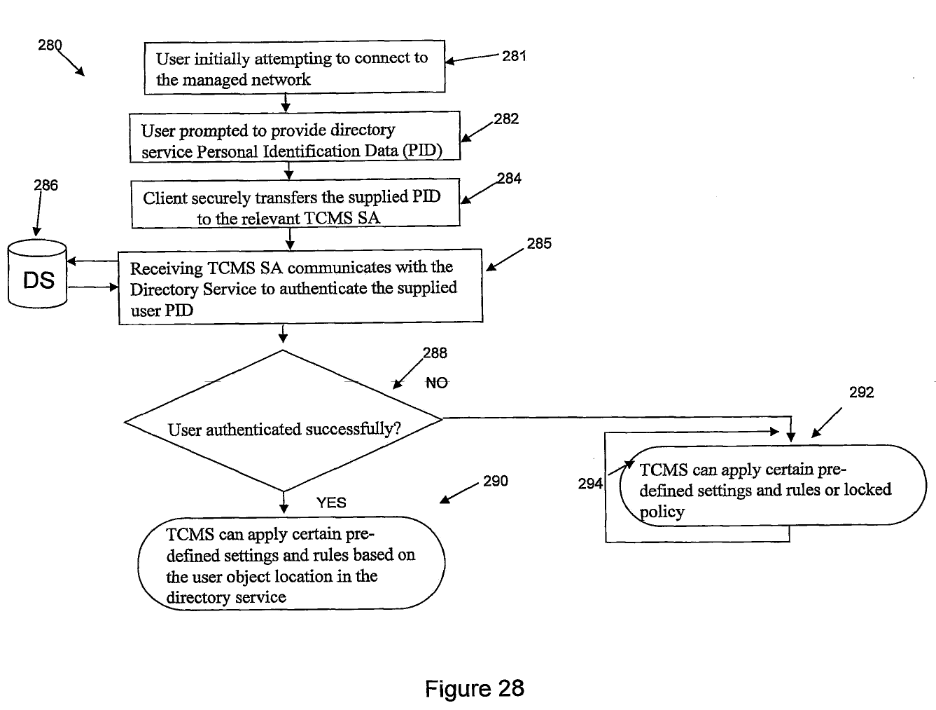

FIG. 28 present user initial connection and authentication sequence as seen in simplified flow-chart 280. The process starts when user attempts to connect to the TCMS managed network 281. User typically needs to supply Personal Identification Data. Depending on the organization's security scheme, user may need to use a second way of authentication (such as token or smart-card) or perform a biometric authentication (fingerprint, iris recognition etc). Authentication information is passed 284 to the appropriate TCMS Secured Authenticator (SA) by means of encrypted protocol. The SA is installable TCMS software intended to enable specific authentication service with specified type of Directory Service. SAs can be installed in TCMS to add authentication services with plurality of standard and proprietary Directory Services as needed by the organization.

The receiving SA then checks (step 285) the received data with the applicable Domain Services 286.

Domain Services 286 provide success or fail results (and additional user information if applicable) back to the SA (step 288).

If authentication was successful (step 290)—the TCMS instructs the client to apply certain settings and policies as defined for that user. Successful authentication event is reported back to the TCMS for event logging purpose. In addition the TCMS may be set to deliver (export) authentication results to external security or other services or systems.

It should be noted that the applied per-user policies and settings initiated by the TCMS upon initial user authentication can be:

Physical location dependant

Logical location dependant

Permission level dependant

Time and Date dependant

Machine (client) dependant

If authentication was unsuccessful (step 292)—the TCMS instructs the client to apply other settings and policies (typically restrictive use or blocked completely) as defined for that user and location. User cannot leave the supplied settings 294 unless successfully authenticated.

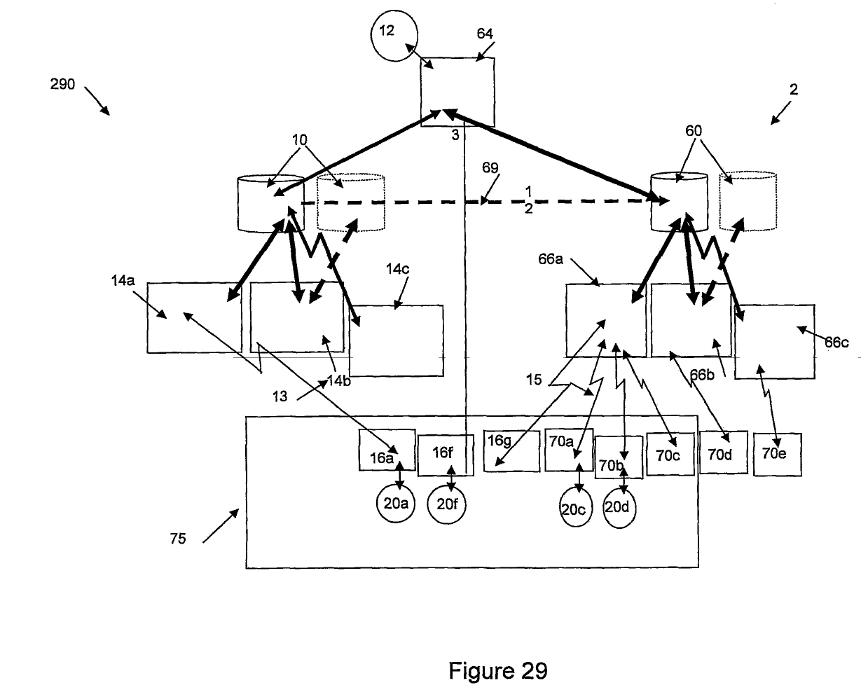

FIG. 29 illustrate yet another configuration of the TCMS managed environment 290 having at least one managed PC. This figure is similar to FIG. 8 but in this case one or more PC device 16g is managed by the TCMS through the FES 66a. In this configuration, the PC 66a is modified into a thin-client by modifying part or all of its operating system and applications and adapt it to be managed by the TCMS. PC management agent may be installed to interface with the TCMS.

This configuration enables the administrator 12 to access the same management console 64 to fully manage thin-clients as well as adapted PCs.

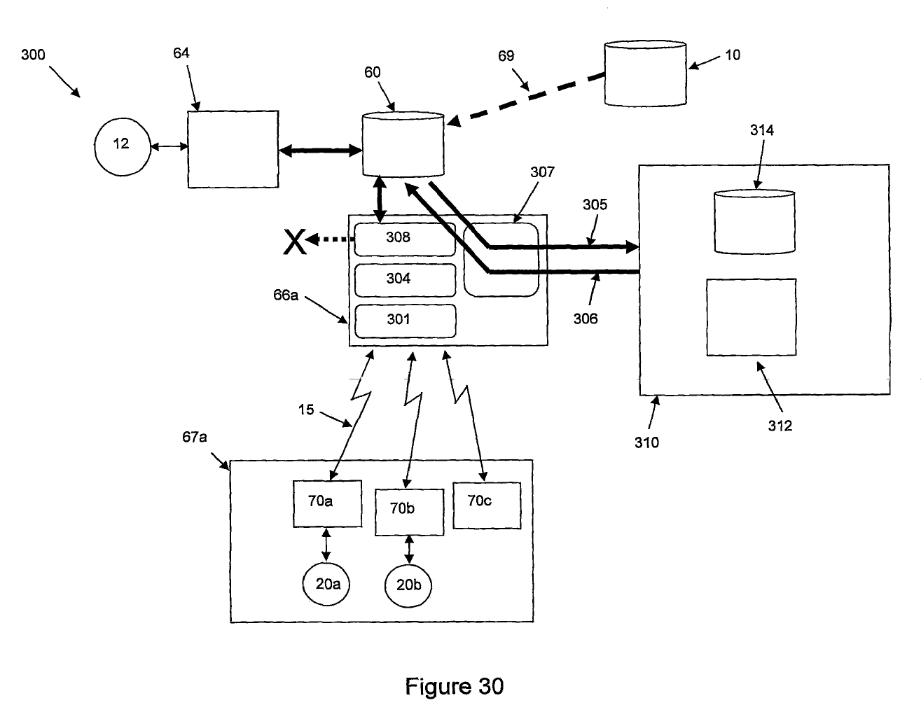

FIG. 30 illustrating a TCMS managed environment 300 according to the present invention, having additional administrative functions highlighted. This TCMS embodiment of the present invention is similar to the system shown in FIG. 6 with some additional functions such as:
a. import export function 307 to external data bases and or applications. This function is useful in order to synchronize the TCMS with other organization applications or data bases or vise versa. External applications such as: Microsoft SMS, IBM Tivoli, HP OpenView, Altiris, Asset Insight, Radia, Remedy, CA TG Unicenter, Oracle based applications, Microsoft Access, Microsoft Excel, SAP, Baan, JD Edwards, NA Magic Help, Marimba, Peoplesoft etc. can be synchronized with the TCMS through Import export module 307. Data to be exported read from the TCMS data base 60 by the said module 307 that resides in the FES or at another accessible server. Data is filtered and parsed if needed and then exported (step 305) to the external application 312 or database 314 at the external system 310. Similarly imported data (step 306) from the external system 310 is read by the module 307, parsed and filtered if needed and then delivered to the TCMS data base 60 for storage. This method can be used to import or export—policies, settings, logical or physical tree structure, user data, logs and events, real-time information, asset data, permission schemes and any other required data. In addition this function may be useful to enable system backup and restore in case that data base becomes corrupted or unavailable.
b. Data base cleaner function 308 responsible for reducing the TCMS data base size. This module resides at the FES 66a or at any accessible server reads data base 60 content at a periodical basis. Based on pre-defined conditions this module may erase some fields in order to reduce data base size.
c. Discovery tools 301 responsible for searching managed clients at the managed network. This function may be useful in order to detect new connected clients. Discovery tools 301 may scan the network using protocols such as SNMP, TCPIP, HTTP or any other standard or proprietary protocol. Information related to detected clients delivered by this module to the data base 60 and or to the administrator console 64. This module can be installed at the FES 66a or at any accessible computer or server.
d. Asset and Software tracking module 304 responsible for managing asset related information such as clients Serial numbers, MAC address, model, image version, operational status, reported user, location, deployment date warranty coverage, SLA status, RMA status etc. This module can also maintain and report essential software licensing and usage information. Collected data can then exported to external applications or data bases by means of import/export module 307 described above.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Multi-level Thin-clients management system (TCMS) comprising
representation of the managed organization structure in the form selected from a group of representations such as graphical, textual and symbolic representation;
per-level configurable management parameters;
per-level configurable administrative permissions;
management console adapted to enable user interaction for administrative purposes;
database containing management parameters selected from a group of parameters such as settings, policies, software components, and logs;
Front End Servers adapted to forward client management information to the TCMS and apply management rules, control functions on clients;
managed device having management agent adapted to communicate and to enable management by the TCMS.

2. The TCMS of claim 1 wherein the TCM is adapted to enable client installable software modules to be deployed on Per-level basis.

3. The TCMS of claim 1 wherein the graphical, textual or symbolic representation of the managed organization structure is based on the network physical layout.

4. The TCMS of claim 1 wherein the graphical, textual or symbolic representation of the managed organization structure is provided with additional logical view representation.

5. The TCMS of claim 1, wherein the graphical, textual or symbolic representation of the managed organization structure is synchronized with the organization's Directory Services that is selected from a group of directory services such as Microsoft, Novell, Unix and any other standard or proprietary Directory Service wherein the synchronization with the Directory Services structure is being performed with our without modification of the Directory Services schema.

6-9. (canceled)

10. The TCMS of claim 2, wherein the management and software deployment protocols can be configurable on per-node/s basis for each one of the following: TCP/IP Socket optimization comprising at least one of port selection and timeouts, bandwidth optimization, Latency optimization, management and software deployment traffic compression to enable optimal network traffic utilization, or management and software deployment traffic encryption secure network traffic such as encrypted management and software deployment protocols to Secure Socket Layer (SSL) based.

11-15. (canceled)

16. The TCMS of claim 2 wherein the management and software deployment is done by single server instance.

17. The TCMS of claim 2, wherein the management and software deployment is done by multiple server instances wherein the multiple server instances are arranged to support server Fault Tolerance or support server Load Balancing.

18. (canceled)

19. (canceled)

20. The TCMS of claim 2 wherein said organization management representation enables viewing Real-time server(s) status and notifications and wherein said Real time view further enables triggering of pre-defined actions, settings, or installable software deployment actions.

21. (canceled)

22. The TCMS of claim 2 wherein remote management and software deployment activities are augmented by remote site server Front End Server having Proxy functions that are used as mediators between Fast Connected LANs and Database Servers residing over slow network links.

23. The TCMS of claim 22 wherein said Front End Server are responsible of:
a. serving as a software distribution agent for the local LAN Thin Clients, confining the deployment traffic to the LAN: and
b. filtering and scheduling outgoing client-information traffic sent from the LAN to Database Servers to reduce WAN traffic.

24. The TCMS of claim 4 wherein said per node/s settings are Policy based wherein the policies are selected from a group of Time and Date Dependent, Permission Dependent, Device Dependent, and group dependent.

25-28. (canceled)

29. The TCMS of claim 5, wherein said directory service administrative permissions are supported by the TCMS synchronization mechanism and wherein said directory service administrative permissions are based on a proprietary permissions mechanism.

30. (canceled)

31. The TCMS of claim 1, wherein said organization management representation enables viewing Real-time clients statuses and notifications and wherein said Real time view enables triggering of pre-defined and installable actions.

32. (canceled)

33. The TCMS of claim 1, wherein initial connection of a client to the managed network comprises the following steps that can be set on per node bases:
a. receiving valid management server parameters by said client;
b. TCMS authenticates that said client is a valid member of that organization;
c. upon negative authentication the TCMS can apply certain pre-defined settings and/or rules and/or policies;
d. upon positive authentication the TCMS can apply certain pre-defined settings and/or rules and/or policies; and
e. TCMS maps the client into the proper location or level within the directory service structures
wherein in the initial client connection process, said authentication process is based on pre-configured unique client parameters selected from the group consisting of MAC, GUID, IP, NAME, and any other unique client property and wherein in the initial client connection process, said authentication process is based on one of manual administrator intervention or automatically authenticating the client based on its network location and wherein, in the initial client connection process, said authentication process is based on directory service authentication wherein the user installing that client is prompted to provide a valid Personal Identification Data (PID) that has permissions to install that client wherein said Personal Identification Data (PID) is selected from the group consisting of User credentials, passwords, certificates, voice recognition, facial recognition, finger print recognition, and other unique user property authentication methods.

34-38. (canceled)

39. The TCMS client of claim 33, wherein in the initial client connection process, said authentication process is being redirected by TCMS installable component called Secured Authenticator (SA).

40. The TCMS client of claim 33, wherein in the client initial connection process, plurality of SA's are added in order to enable client authentication in front of plurality of security realms used by the organization.

41. The TCMS of claim 1 wherein initial connection of a user to the managed network comprises the following steps that can be set on per node basis:
a. user is prompted by said client to provide directory service Personal Identification Data (PID);
b. said client securely transfers the supplied PID to the relevant TCMS SA;
c. TCMS relevant SA communicates with the directory service to authenticate the supplied user PID;
d. upon negative authentication the TCMS can apply certain pre-defined settings and rules; and
e. upon positive authentication the TCMS can apply certain pre-defined settings and rules based on the user object location in the directory service.

42. The TCMS of claim 41, wherein in initial user connection process, said user authentication process is based on pre-configured user account that are applied automatically by the SA, directory service authentication wherein the user connecting at that client is prompted to provide a valid directory service PID that has permissions to connect, or is further augmented by hardware accessories authentication means such selected from the group consisting of smart-card, tokens, and biometrics, or wherein plurality of SA's is added to enable user authentication in front of plurality of security realms used by the organization.

43-45. (canceled)

46. The TCMS of claim 41 wherein in initial user connection process, said user authentication process, results and parameters are exported to other pre-defined organization's systems to enable security and users management or other required functions.

47. The TCMS of claim 1, wherein plurality of management parameters are extracted from the system to be displayed and stored in plurality of log files wherein said log is configured to generate predefined actions and alerts, wherein the management console is implemented based on Web based GUI or any other remote published GUI. Microsoft MMC snap-in or based on Proprietary programmed GUI.

48-51. (canceled)

52. The TCMS of claim 1 wherein said data base is selected from a group comprising database such as Microsoft SQL, Microsoft Access, IBM DB-2, Oracle or any other standard or proprietary data base.

53. The TCMS of claim 1 wherein TCMS components further comprising at least one Managed Personal Computers (PCs) and wherein the managed PC is further at least partially converted into a thin-client functionality by modifying or replacing some or all of its Operating System components and local software applications components and wherein plurality of installable software components, policies, utilities, new functionality and server installable objects can be added after initial system deployed by means of deployable modular components.

54. (canceled)

55. (canceled)

56. The TCMS of claim 1 wherein the said functions further comprises at least one of the following utilities:
a. Discovery tools: allows scanning TCP/IP networks using various protocols selected from the group of: SNMP and HTTP;
b. Import/Export Topology function which allows importing/exporting a physical and logical topology into the TCMS;
c. Import/Export Permissions function which allows importing/exporting permission schemes at any level;
d. Import/Export database content function which allows importing/exporting the database content for backup and/or replication needs; and
e. Database Cleaner function which allows reducing the database size by removing selected record types.

57. The TCMS of claim 1, wherein plurality of management parameters can be extracted from the system to external third party applications such as Microsoft SMS 2003 and/or other management, support and asset tracking applications and wherein the function further comprises at least one of the following utilities:
a. Hardware Inventory used for device tracking by unique asset management information comprises at least one of: unique identifier, IP Address, GUID, MAC, Serial Number, NAME and Model version.
b. Software tracking providing at least on of: installed software history details, uninstalled software history details and software usage details.

58. (canceled)
